(19) United States
(12) Patent Application Publication
(10) Pub. No.: US 2015/0240397 A1
(43) Pub. Date: Aug. 27, 2015

(54) MESH MEMBER, METHOD OF PRODUCING MESH MEMBER, AND LIQUID DISCHARGING APPARATUS

(71) Applicant: SEIKO EPSON CORPORATION, Tokyo (JP)

(72) Inventor: Eiji KUMAI, Matsumoto-shi (JP)

(21) Appl. No.: 14/612,876

(22) Filed: Feb. 3, 2015

(30) Foreign Application Priority Data
Feb. 27, 2014 (JP) 2014-036970

(51) Int. Cl. D03D 49/12; B05C 9/14; B05B 13/02

(52) U.S. Cl. CPC D03D 49/12; B05B 13/0221; B05C 9/14

(57) ABSTRACT

A mesh member includes first strands extending in a first direction and second strands extending in a second direction intersecting the first direction. The first strands and the second strands are woven together to cross over and under each other and form a mesh structure. The first strands each have a larger cross-sectional area than the second strands at intersections where the first strands and the second strands cross each other.

### BACKGROUND

1. Technical Field

The present invention relates to a mesh member including first strands and second strands that are woven together to cross over and under each other. The first strands extend in a first direction and the second strands extend in a second direction intersecting the first direction. The invention further relates to a method of producing a mesh member characterized by how to weave first strands and second strands, and a liquid discharging apparatus including the mesh member as a part of a medium supporter for supporting a medium onto which liquid is discharged.

2. Related Art

Known mesh members include first strands extending in a first direction and second strands extending in a second direction intersecting the first direction. The first strands and second strands are woven together to cross over and under each other. The mesh members have been widely used in products for various applications such as fishing gear, insect-repelling nets, and wire mesh. The known mesh members have similar configurations and have no difference in how they are to be woven. The known mesh members differ from each other only in diameter or kind of the strands, or in mesh size.

As described in patent documents, JP-A-2000-75773 and JP-A-10-217572, it was attempted to use the mesh member as a component of a medium supporter of a thermal transfer printer. The above patent documents describe that a sling such as a mesh is disposed at a portion of a medium transporting passage. According to the patent documents, vapor generated by heat is released through openings in the sling to the outside, which prevents moisture from attaching to the medium.

The medium on the mesh member moves relative to the mesh member when the mesh member is used in the medium supporter, as described in the above patent documents. In this case, the following problems may occur. Specifically, as illustrated in FIG. 11, a sheet 103 as a medium is transported in a predetermined direction, for example in a direction along the first strand 107, on a mesh member 101 including first strands 107 and second strands 109 that are woven together to cross over and under each other. In this case, a front corner 105 or another part of the sheet 103 may catch on the second strand 109 that stretches in a direction Y intersecting a transporting direction X of the sheet 103. This may cause a transportation defect such as a paper jam. Additionally, the front corner 105 or another part of the sheet 103 may be folded or damaged.

### SUMMARY

An advantage of some aspects of the invention is that a mesh member having a non-conventional and a novel structure is provided and the application range of the mesh member is widened. Another advantage is that the risk that the medium will catch on the mesh member, which is used as the medium supporter, is reduced. Still another advantage is that a liquid discharging apparatus including the mesh member and having high transportation stability is provided.

A mesh member according to an aspect of the invention includes first strands extending in a first direction and second strands extending in a second direction intersecting the first direction. The first strands and the second strands are woven together to cross over and under each other and form a mesh structure. The first strands each have a larger cross-sectional area than the second strands at intersections where the first strands and the second strands cross each other.

In this aspect, when the mesh member is used as a part of the medium supporter that allows the medium to move on the mesh member while supporting the medium, the medium is mainly in contact with the first strands each having a larger cross-sectional area when supported by the mesh member. The front corner or another part of the medium is less likely to catch on the second strand. Thus, risk of a transportation defect and damage to the medium is reduced.

In the mesh member, each of the first strands may have a larger diameter than each of the second strands.

In this case, the mesh structure including the first strands each having a larger cross-sectional area than the second strands at the intersections can be readily provided, since the first strands each have a larger diameter than the second strands.

The mesh member may be made of stainless steel. The diameter of each of the first strands may be 300 μm or less. The diameter of each of the second strands may be 70 μm or more.

In this case, since the stainless steel is unlikely to be easily cooled down due to its low thermal conductively compared to other metal materials, the mesh member can have an improved heating efficiency when the mesh member is heated by application of an electromagnetic wave such as an infrared ray. Furthermore, since the first strand has the diameter of 300 μm or less, condensation is less likely to occur on the mesh member, and thus the liquid is less likely to attach to the medium on the mesh member. Furthermore, since the second strand has the diameter of 70 μm or more, the mesh member can have sufficiently high strength.

In the mesh member, a ratio of the diameter of each of the first strands to the diameter of each of the second strands may be in a range of 2:1 to 4:1.

In this state, the above ratio enables the mesh member not to be too thick and the mesh structure to have well-balanced diameters of the first strands and the second strands, which reduces the risk that the medium will catch on the mesh member.

In the mesh member, at the intersections in the mesh structure, the first strands each may include a bundle of strands, and each second strand may include one strand or a bundle of strands. The number of strands in the bundle of the first strand is smaller than the number of strands in the in the bundle of the second strand.

In this state, the medium is supported on the mesh member while being in contact with the first strand at as many supporting points as the strands in the first strands. Thus, smaller contact pressure is applied to each supporting point, which reduces sag of the medium.

In the mesh member, the first strands adjacent to each other may have a smaller interval therebetween than the second strands adjacent to each other.

In this state, the supporting points, at which the medium is supported, are arranged at smaller intervals in the second direction, which reduces sag of the medium supported on the mesh member.

In the mesh member, the intersections of the mesh member may include first intersections where the first strands are positioned over the second strands and second intersections where the second strands are positioned over the first strands. In the horizontally orientated mesh member, tips of the first strands at the first intersections may be positioned higher than tips of the second strands at the second intersections.

In this state, the mesh member is supported by the mesh member while mainly being in contact with the first strands, which have the tips at the higher positions. Thus, the front corner or another part of the medium is less likely to catch on the second strand, which reduces the risk of a transportation defect and damage to the medium.

In the mesh member, the mesh member is configured such that a medium having a sheet form and placed on the mesh member is in contact with the tips of the first strands at the first intersections, where the first strands are positioned over the second strands, and is not in contact with the tips of the second strands at the second intersections, where the second strands are positioned over the first strands.

In this state, the medium is always in contact with and supported by the first strands, when the medium moves on the mesh member. Thus, although the medium is likely to sag at the intersections where the second strands are positioned over the first strands, the front corner or another part of the medium is less likely to be in contact with and caught on the second strand.

The mesh member may have an opening percentage in a range of 10% to 60%.

In this state, vapor generated on one side of the mesh member sufficiently passes through the openings of the mesh member to the other side, since the mesh member has an opening ratio of 10% or more. Thus, the liquid is less likely to attach to the medium, which may be caused by low permeability.

According to an aspect of the invention, a method of producing a mesh member is provided. The method includes weaving first strands extending in a first direction and second strands extending in a second direction intersecting the first direction so as to cross over and under each other and form a mesh structure. The first strands each have a larger diameter than the second strands. The method further includes tensioning the second strands with a large force during weaving such that the second strands are stretched linearly at the intersections where the first strands and the second strands intersect each other, and tensioning the first strands with a small force during weaving such that the first strands each form a wavy shape.

As described above, the first strands and the second strands are tensioned with different forces during the weaving. Thus, the mesh member including the first strands each having the larger cross-sectional area than the second strands at the intersections can be readily produced.

According to an aspect of the invention, a liquid discharging apparatus is provided. The liquid discharging apparatus includes a liquid discharging head configured to discharge liquid onto a medium, a medium support configured to support the medium onto which the liquid is discharged, a heater configured to heat and dry the liquid discharged onto the medium, and a transportation unit configured to transport the medium in a predetermined direction. The medium supporter may include at least a part composed of the above-described mesh member.

In this state, the liquid discharging apparatus had high transportation stability in which the risk that the mediums will catch on the medium supporter is reduced. The liquid discharging apparatus includes the medium supporter having desired characteristics of sufficiently high permeability to vapor generated through the vaporization of the discharged liquid and high strength enabling the medium supporter to be repeatedly used.

### BRIEF DESCRIPTION OF THE DRAWINGS

The invention will be described with reference to the accompanying drawings, wherein like numbers reference like elements.

FIG. 1 is a perspective view illustrating a mesh member in a first embodiment of the invention.

FIG. 2A is a plan view illustrating a part of the mesh member in the first embodiment of the invention.

FIG. 2B is a front view corresponding to FIG. 2A.

FIG. 2C is a side view corresponding to FIG. 2A.

FIG. 3A is a magnified front view illustrating a part of the mesh member in the first embodiment of the invention.

FIG. 3B is a side view corresponding to FIG. 3A.

FIG. 4A is a plan view illustrating a part of a mesh member in a second embodiment of the invention.

FIG. 4B is a front view corresponding to FIG. 4A.

FIG. 4C is a side view corresponding to FIG. 4A.

FIG. 5A is a magnified view illustrating a part of the mesh member in the second embodiment of the invention.

FIG. 5B is a side view corresponding to FIG. 5A.

FIG. 6A is a plan view illustrating a part of a mesh member in a third embodiment of the invention.

FIG. 6B is a front view corresponding to FIG. 6A.

FIG. 6C is a side view corresponding to FIG. 6A.

FIG. 7 is a table indicating differences in factors depending on types of mesh members in the embodiments of the invention.

FIG. 8A is a magnified view illustrating a method of producing a mesh member in a fourth embodiment of the invention.

FIG. 8B is a side view corresponding to FIG. 8A.

FIG. 9 is a schematic view illustrating a schematic structure of a liquid discharging apparatus in a fifth embodiment of the invention.

FIG. 10 is a cross-sectional side view illustrating a medium supporter and parts around the medium supporter of the liquid discharging apparatus in the fifth embodiment.

FIG. 11 is a plan view illustrating a conventional mesh member and a problem in the mesh member.

### DESCRIPTION OF EXEMPLARY EMBODIMENTS

Hereinafter, a mesh member of the invention, a method of producing a mesh member, and a liquid discharging apparatus, according to aspects of the invention will be described in detail.

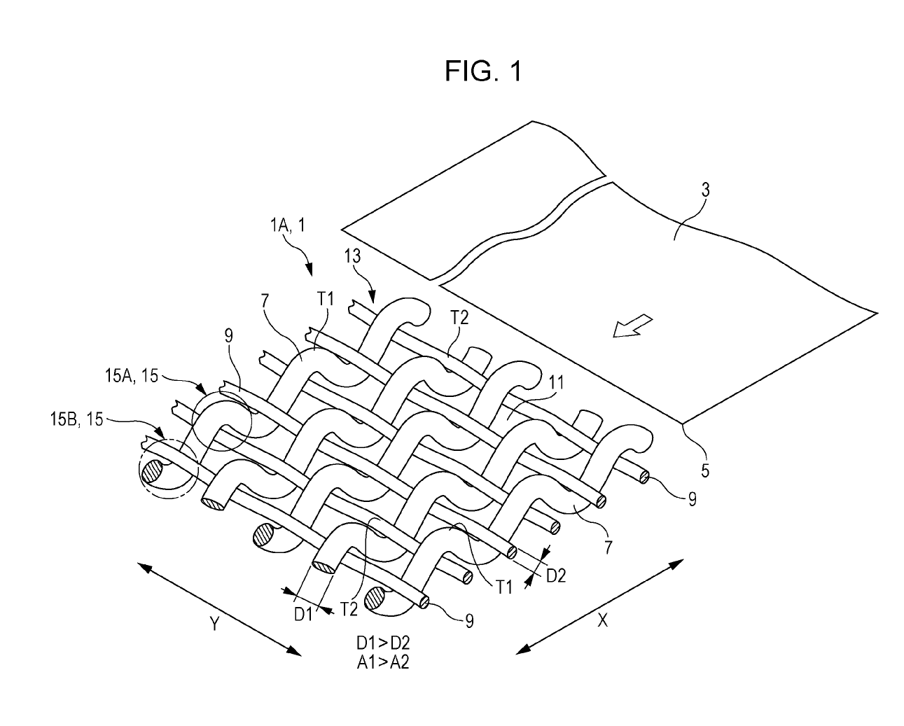

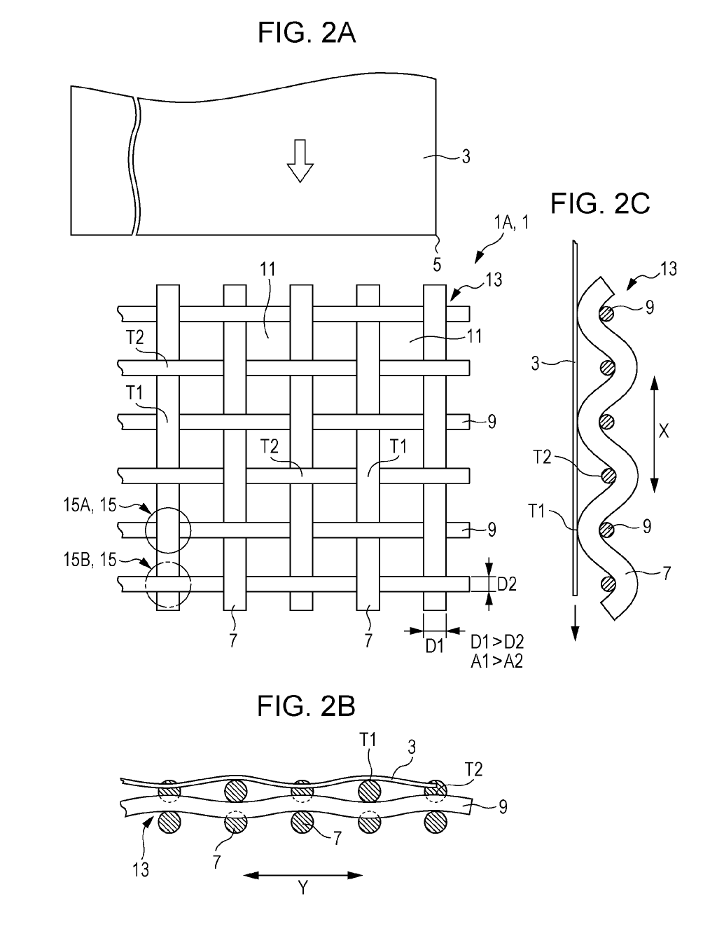

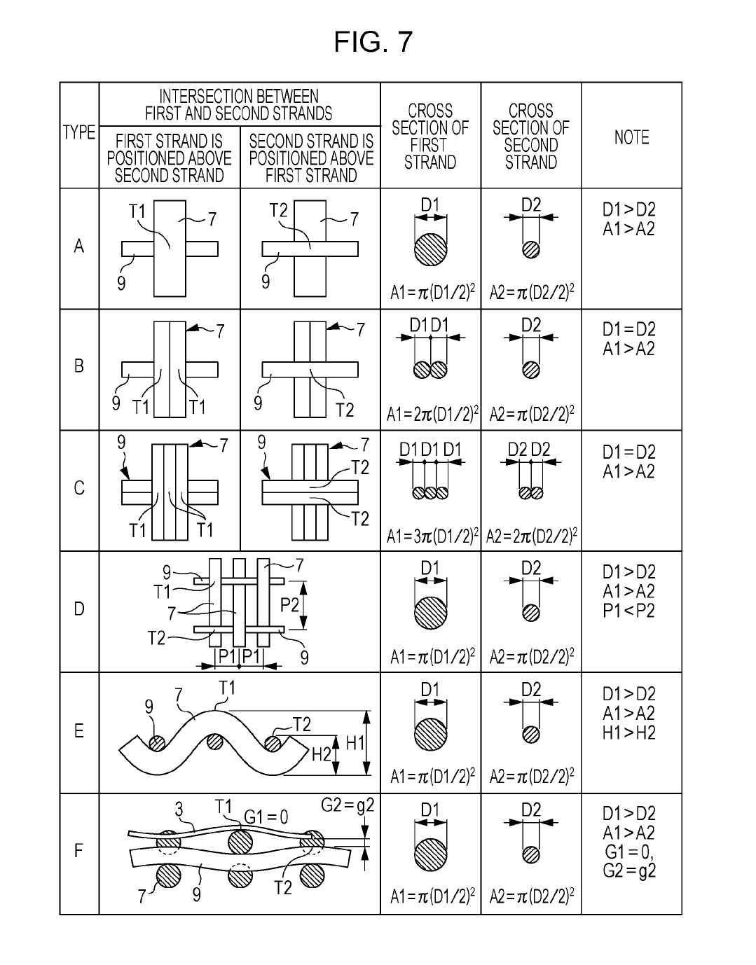

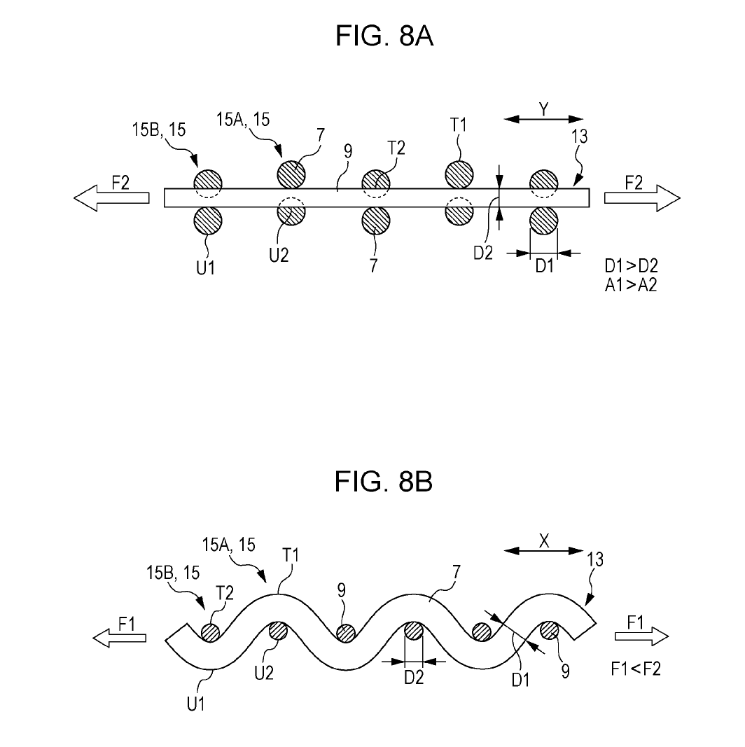

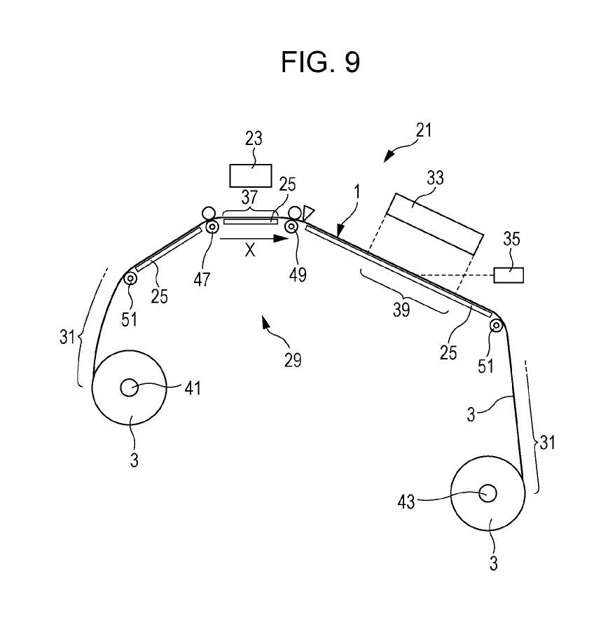

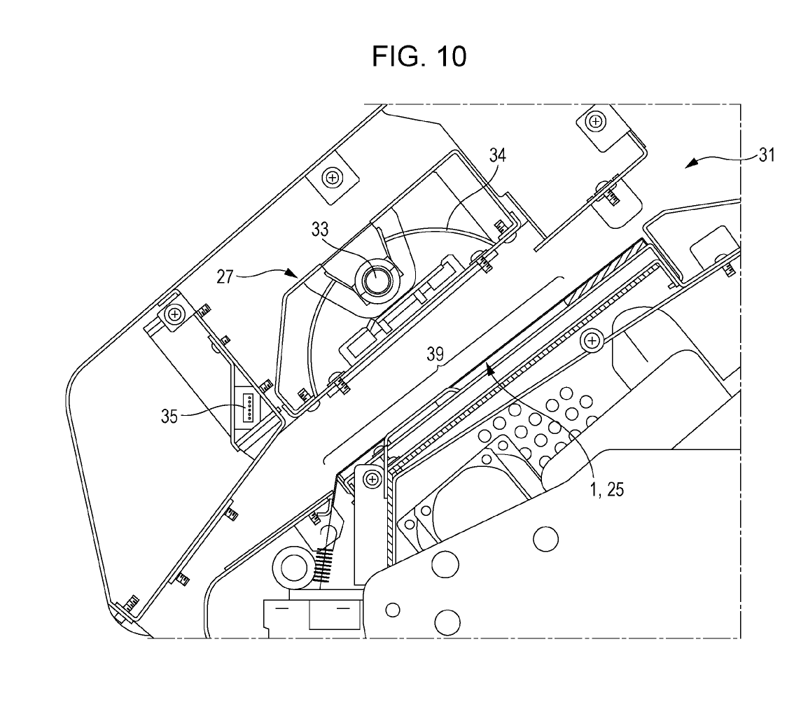

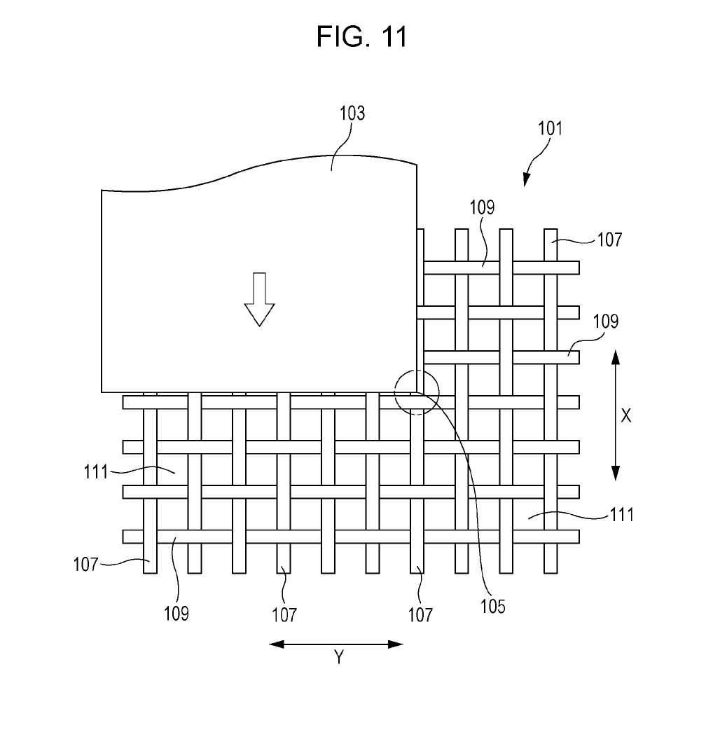

In the following description, initially, a configuration and an operation of a mesh member 1 according to an aspect of the invention will be described with reference to FIGS. 1 to 6C, which illustrate first to third embodiments, and to FIG. 7, which indicates differences in factors depending on types of mesh members. Then, steps and an operation of the method of producing a mesh member according to an aspect of the invention will be described with reference to FIGS. 8A and 8B, which illustrate a fourth embodiment. Finally, a configuration and an operation of a liquid discharging apparatus according to an aspect of the invention will be described with reference to FIGS. 9 and 10, which illustrate a fifth embodiment.

### First Embodiment

A first Embodiment will be described with reference to FIGS. 1 to 3B and types A, E, and F in FIG. 7. A mesh member 1 according to an aspect of the invention includes first strands 7 extending in a first direction X and second strands 9 extending in a second direction Y intersecting the first direction X. The first strands 7 and the second strands 9 are woven together to cross over and under each other and form a mesh structure 13. In the mesh member 1, the first strands 7 each have a cross-sectional area A1 that is larger than a cross-sectional area A2 of each second strand 9 at intersections 15 where the first strands 7 and the second strands 9 cross each other.

In a mesh member 1A in the first embodiment, the first strand 7 has a diameter D1 larger than a diameter D2 of the second strand 9. This enables the first strand 7 to have a cross-sectional area A1 larger than a cross-sectional area A2 of the second strand 9.

In this embodiment, the mesh member 1A is made of stainless steel. The stainless steel, which is a metal material, has high mechanical strength and is unlikely to be easily cooled down due to its low thermal conductivity. Thus, the mesh member 1A may exhibit higher heating efficiency, when an electromagnetic wave such as an infrared ray is applied to the mesh member 1A, for example.

The first strand 7 preferably has a diameter D1 of 300 μm or less. The second strand 9 preferably has a diameter D2 of 70 μm or more. The first strand 7 having the diameter D1 of 300 μm or less reduces the chance of condensation on the mesh member 1A when vapor is generated on one surface of the mesh member 1A. This reduces the risk that liquid will attach to the medium 3 on the mesh member 1A. The second strand 9 having the diameter D2 of 70 μm or more enhances the strength of the mesh member 1A. This reduces wear of the mesh member 1A if the media 3 are frequently transported on the mesh member 1A, and thus the mesh member 1A is less likely to be damaged if the medium 3 is caught on the mesh member 1A.

The diameter of the first strand 7 is preferably determined such that the first strand 7 has a larger cross-sectional area than the second strand 9 at the intersection 15 where the first strand 7 and the second strand 9 intersect. The first strand 7, of the woven mesh member 1A, which is to be in contact with the medium 3, preferably has a larger diameter than the second strand 9. With this configuration, the second strand 9 is less likely to come into contact with the medium 3, which reduces the risk that the front corner or another part of the medium 3 will catch on the second strand 9. The first strand 7 may have a part having a smaller diameter than the diameter of the part at the intersection. The first strand 7 may have the same diameter at the intersection and at the parts other than the intersection. In other words, the first strand 7 may have a constant diameter over its length.

A ratio between the diameter D1 of the first strand 7 and the diameter D2 of the second strand 9 is preferably within a range of 2:1 to 4:1. This ratio can provide a mesh structure having a well-balanced diameter of the first strand 7 and the second strand 9. Specifically, in this mesh structure, the mesh member 1A does not have too large a thickness, and the risk that the medium 3 will catch on the mesh member 1A is reduced.

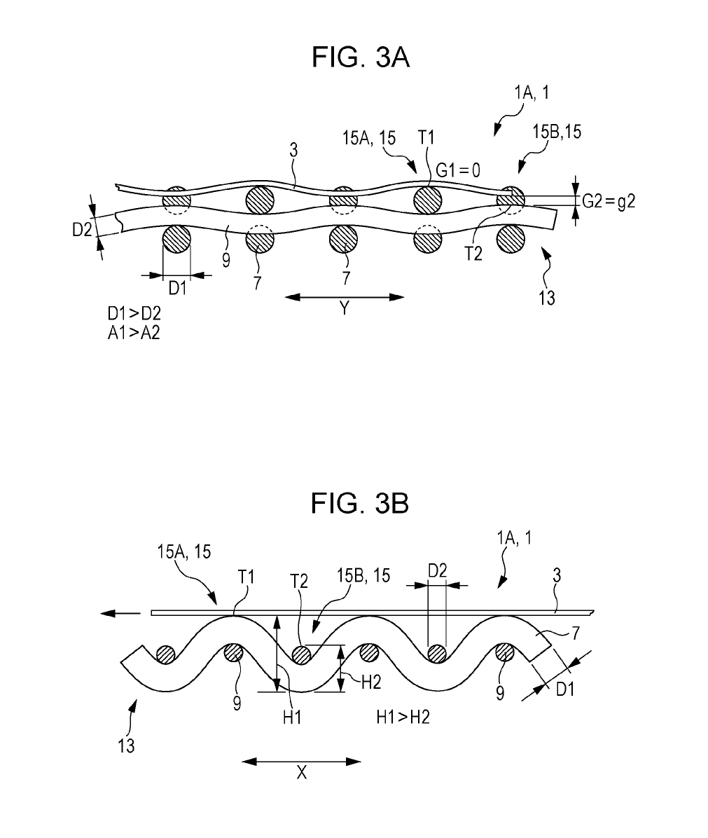

As illustrated in FIG. 3B, a tip T1 of each first strand 7 at each first intersection 15A, where the first strand 7 is positioned over the second strand 9, is located at a position H1. A tip T2 of each second strand 9 at each second intersection 15B, where the second strand 9 is positioned over the first strand 7, is located at a position H2. The position H1 is preferably positioned higher than the position H2.

The medium 3 is supported while being in contact with the tips T1 of the first strands 7 at the first intersections 15A, where the first strands 7 are positioned over the second strands 9, when the medium 3 in a sheet form is placed on the mesh member 1A. In this state, a gap G1 between the medium 3 and the first strands 7 is zero. Meanwhile, the medium 3 is not in contact with the tips T2 of the second strands 9 and is positioned over the tips T2 at the second intersections 15B, where the second strands 9 are positioned over the first strands 7. In this state, a gap G2 between the medium 3 and the second strand 9 is indicated as g2. The medium 3 and the second strand 9 forms a gap therebetween.

The mesh member 1A preferably has an opening percentage in a range of 10% to 60%. The mesh member 1A having the opening percentage of 10% or more sufficiently allows vapor generated on one side of the mesh member 1A to pass through the opening 11 to the other side. This reduces the risk that liquid will attach to the medium 3, possibly due to low permeability. The mesh member 1A having an opening percentage of 60% or less reduces the risk that the front corner 5 or another part of the medium 3 will catch on the second strand 9 when the medium 3 is moved on the mesh member 1A.

In the mesh member 1A having the above configuration of this embodiment, a simple configuration, in which the diameter D1 of the first strand 7 is larger than the diameter D2 of the second strand 9, reduces the risk that the front corner 5 or another part of the medium 3 will catch on the second strand 9 when the medium 3 is moved on the mesh member 1A. This reduces the risk of a transportation defect or damage to the medium 3, because the front corner 5 of the medium 3 is less likely to catch on the second strand 9.

### Second Embodiment

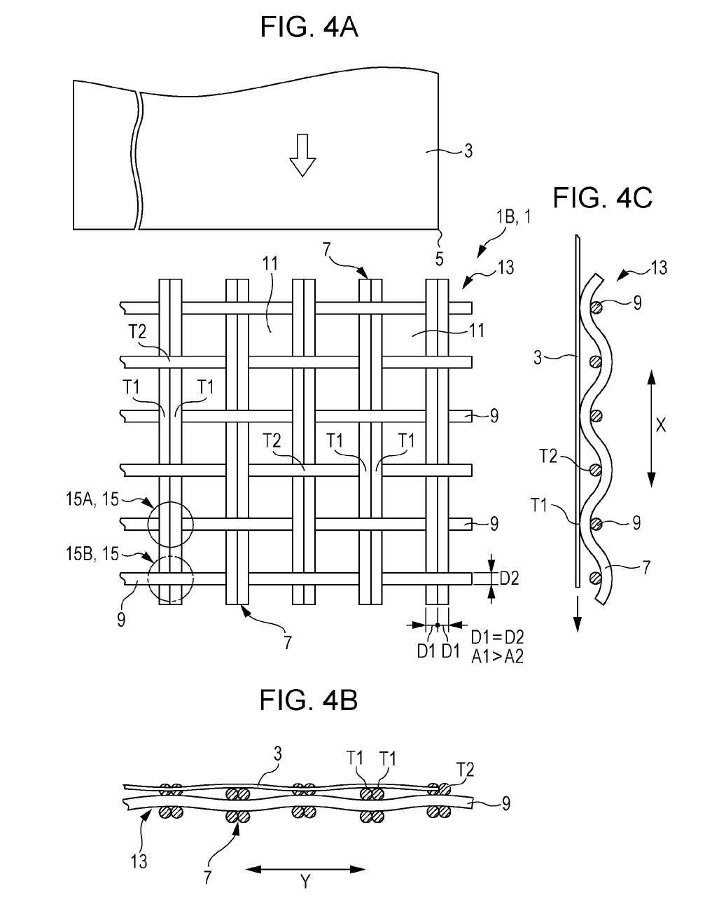

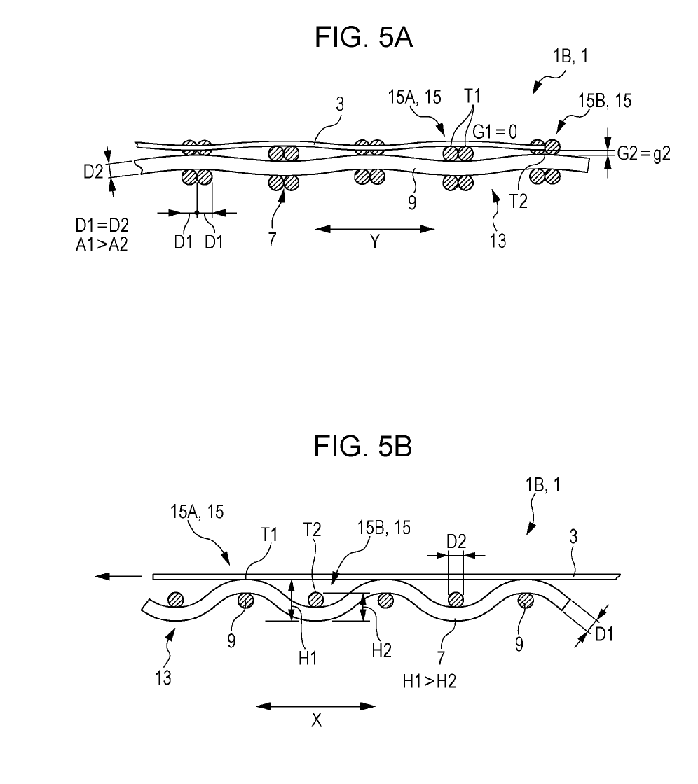

A second embodiment will be described with reference to FIGS. 4A to 4C, 5A, and 5B, and to types B and C in FIG. 7. In a mesh member 1B in the second embodiment, at the intersections 15, where the first strands 7 and the second strands 9 intersect, the first strands 7 each include a bundle of strands and the second strand 9 includes one strand or a bundle of strands. The number of strands in the second strand 9 is smaller than the number of strands in the first strand 7. This allows the first strand 7 to have a larger cross-sectional area A1 than the cross-sectional area A2 of the second strand 9 in the mesh structure 13.

In FIGS. 4A to 4C, 5A, and 5B, and in the type B in FIG. 7, the first strand 7 is a bundle of two strands and the second strand 9 includes one strand, and the diameter D1 of each strand in the first strand 7 and the diameter D2 of the strand in the second strand 9 are the same. In the mesh member 1B having the above configuration, as indicated by the type B in FIG. 7, an equation D1=D2, in which D1 is a diameter of each strand in the first strand 7 and D2 is a diameter of the strand in the second strand 9, is satisfied, and an equation A1>A2, in which A1 is a cross-sectional area of the first strand 7 as a bundle of two strands and A2 is a cross-sectional area of the second strand 9 as one strand, is satisfied.

At the first intersection 15A, where the first strand 7 is positioned over the second strand 9, the tips T1 of two strands of the first strand 7 come into contact with the medium 3. The tips T1 are supporting points at which the first strand 7 supports the medium 3. In such a configuration, a smaller contact pressure is applied to one supporting point compared to the case in which only one tip T1 is provided. This reduces sag of the medium 3. At the second intersection 15B, where the second strand 9 is positioned over the first strand 7, the medium 3 is positioned over the tip T2 of the second strand 9, which includes one strand, and does not come into contact with the tip T2 of the second strand 9.

As indicated by the type C in FIG. 7, the diameter D1 of each strand in the first strand 7 and the diameter D2 of each strand in the second strand 9 are the same. The first strand 7 is a bundle of three strands and the second strand 9 is a bundle of two strands, which is smaller in number than the first strand 7 by one. In the mesh member 1B having the above configuration, as indicated by the type C in FIG. 7, the equation D1=D2, in which D1 is a diameter of each strand in the first strand 7 and D2 is a diameter of each strand in the second strand 9, is satisfied, and the equation A1>A2, in which A1 is a cross-sectional area of the first strand 7 as a bundle of three strands and A2 is a cross-sectional area of the second strand 9 as a bundle of two strands, is also satisfied.

At the first intersection 15A, where the first strand 7 is positioned over the second strand 9, the tips T1 of three strands in the first strand 7 come into contact with the medium 3. The tips T1 are supporting points at which the first strand 7 supports the medium 3. Thus, a smaller contact pressure is applied to one supporting point, which reduces sag of the medium 3. At the second intersection 15B, where the second strand 9 is positioned over the first strand 7, the medium 3 is positioned over the tips T2 of the second strand 9 as a bundle of two strands and does not come into contact with the tips T2 of the second strand 9, as in the above-described embodiment.

In the mesh member 1B having the above configuration of this embodiment, at the intersections 15 where the first strands 7 and the second strands 9 cross each other, the number of strands in the first strand 7 is set larger than that in the second strand 9. This simple configuration reduces the risk that the front corner 5 or another part of the medium 3 will catch on the second strand 9 when the medium 3 is moved on the mesh member 1B. Thus, as in the first embodiment, this reduces the risk of a transportation defect and damage to the medium 3, since the front corner 5 or another part of the medium 3 is less likely to catch on the second strand 9.

### Third Embodiment

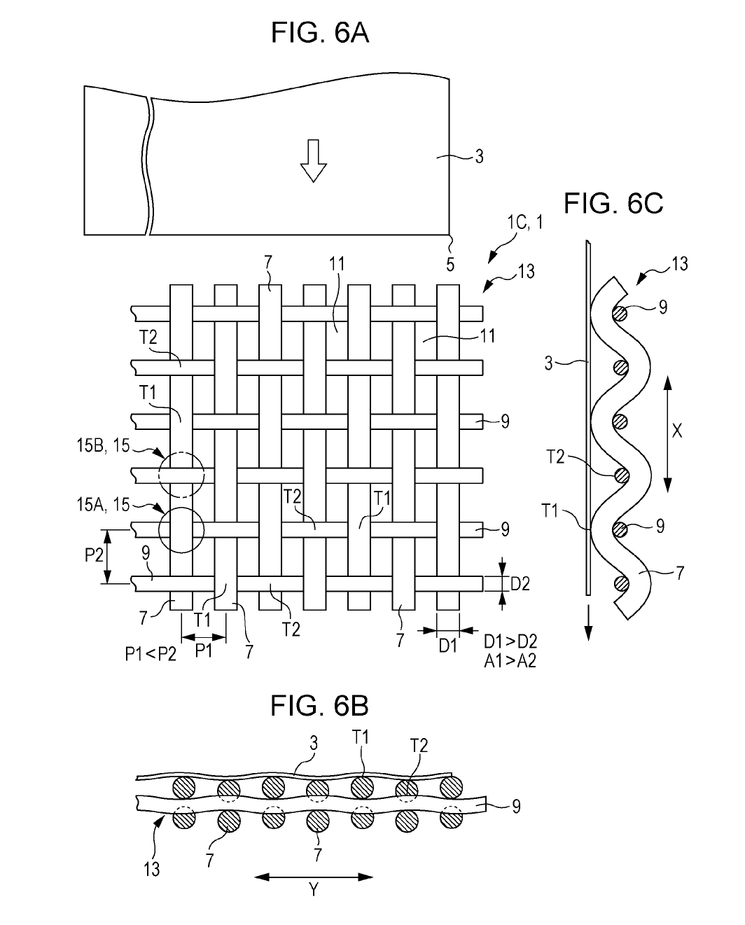

A third embodiment will be described with reference to FIGS. 6A to 6C and to type D in FIG. 7. In a mesh member 1C in the third embodiment, the first strand 7 has a cross-sectional area A1 larger than a cross-sectional area A2 of the second strand 9, and an interval P1 between adjacent first strands 7 is smaller than an interval P2 between adjacent second strands 9. In FIGS. 6A to 6C and in the type D in FIG. 7, as in the first embodiment, the diameter D1 of the first strand 7 is larger than the diameter D2 of the second strand 9. Thus, the equation D1>D2, in which D1 and D2 are the diameters of the first strand 7 and the second strand 9, respectively, is satisfied. Accordingly, the equation A1>A2, in which A1 and A2 are the cross-sectional areas of the first strand 7 and the second strand 9, respectively, is also satisfied. Additionally, in this embodiment, an equation P1<P2, in which P1 is an interval between adjacent first strands 7 and P2 is an interval between adjacent second strands 9, is satisfied.

With this configuration, the medium 3 on the mesh member 1C is moved while being supported at the supporting points (the tips T1 of the first strands 7) that are arranged at small intervals in a second direction Y. This reduces sag of the medium 3. The medium 3 is positioned over the tips T2 of the second strands 9, and thus the medium 3 does not come into contact with the tips T2 of the second strands 9.

In the mesh member 1C having the above configuration of this embodiment, the diameter D1 of the first strand 7 is larger than the diameter D2 of the second strand 9, and the interval P1 between adjacent first strands 7 is smaller than the interval P2 between adjacent second strands 9. This simple configuration reduces the risk that the front corner 5 or another part of the medium 3 will catch on the second strand 9 when the medium 3 is moved on the mesh member 1C. As in the first embodiment, this reduces the risk of a transportation defect and damage to the medium 3, since the front corner 5 or another part of the medium 3 is less likely to catch on the second strand 9.

In the third embodiment, the diameter D1 of the first strand 7 is larger than the diameter D2 of the second strand 9. However, the first strand 7 and the second strand 9 may have the same diameter, or the number of strands in the first strand 7 may be larger than that in the second strand 9, as indicated in FIGS. 4A to 4C and by the types B and C in FIG. 7. The same advantages can be obtained by employing such configurations.

### Fourth Embodiment

A fourth embodiment will be described with reference to FIGS. 8A and 8B and FIGS. 1 to 3B. An aspect of the invention provides a method of producing a mesh member including the first strands 7 extending in the first direction X and the second strands 9 extending in the second direction Y intersecting the first direction X. The first strands 7 and the second strands 9 are woven together to cross over and under each other and form a mesh structure 13. Specifically, a large tensile force F2 is applied to the second strands 9 each having a smaller diameter (a smaller cross-sectional area A2) than the first strand 7, during weaving, such that the second strands 9 are stretched linearly. Meanwhile, a small tension F1 is applied to the first strands 7 each having a larger diameter (a large cross-sectional area A1) than the second strands 9 during weaving such that the first strands 7 each form a wave-like shape.

According to the method of producing a mesh member in this embodiment, the first strands 7 and the second strands 9 are woven with different tensions as described above. Thus, the mesh member 1, in which the first strands 7 each have the cross-sectional area A1 larger than the cross-sectional area A2 of each second strand 9 at the intersections 15, where the first strand 7 and the second strand 9 intersect each other, can be readily produced. For example, the mesh member 1A illustrated in FIG. 1 to FIG. 3B described in the first embodiment can be produced according to this method. In the mesh member 1A produced by this method, the first strand 7 is in a wave-like form in which the tip T1 and the bottom U1 thereof are positioned outward of the second strand 9, and the second strand 9 stretches linearly with little undulation such that the tip T2 and the bottom U2 thereof are positioned inward of the first strand 7. In this configuration, the medium 3 is moved on the mesh member 1A while being in contact with and supported by the tips T1 of the first strands 7 that are positioned outward of the second strands 9. This reduces the risk of a transportation defect and damage to the medium 3, since the front corner 5 or another part of the medium 3 is less likely to catch on the second strand 9.

In the fourth embodiment, the first strand 7 has the diameter D1 larger than the diameter D2 of the second strand 9. However, the first strand 7 and the second strand 9 may have the same diameter, or the number of strands in the first strand 7 may be larger than that in the second strand 9, as indicated in FIGS. 4A to 4C and by the types B and C in FIG. 7. The above-described method is applicable to the production of mesh members having such configurations, and the same advantages can be obtained.

### Fifth Embodiment

A fifth embodiment will be described with reference to FIGS. 9 and 10 and FIGS. 1 to 3B. A liquid discharging apparatus 21 in this embodiment will be described as an ink jet printer, for example. The liquid discharging apparatus 21 includes a liquid discharging head 23 configured to discharge liquid onto the medium 3, a medium supporter 25 configured to support the medium 3 on which the liquid is discharged, a heater 27 configured to heat and dry the liquid on the medium 3, and a transportation unit 29 configured to transport the medium 3 in a predetermined direction.

In this embodiment, at least a part of the medium supporter 25 is composed of the above-described mesh member 1. Specifically, at least a part of the medium supporter 25 is the mesh member 1 including the first strands 7 extending in the first direction X along the transportation direction of the medium 3 and the second strands 9 extending in the second direction Y intersecting the first direction X. The first strands 7 and the second strands 9 are woven together to cross over and under each other and form the mesh structure 13. The cross-sectional area A1 of each first strand 7 at the intersections 15, where the first strands 7 and the second strands 9 cross each other, is larger than the cross-sectional area A2 of each second strand 9 at the intersection 15.

Specifically, in this embodiment, the mesh member 1A, 1B, or 1C having the above configuration described in the first to third embodiments is applicable to at least a part of the medium supporter 25. In this embodiment, for example, the heater 27 includes an irradiation portion 33 configured to apply an electromagnetic wave such as an infrared ray. In this embodiment, the liquid is ink. The liquid component of the ink is heated and dried by the radiant heat of the electromagnetic wave to fix the pigment in the ink on the surface of the medium 3. The transportation unit 29 is configured to transport the medium 3 from upstream to downstream in the first direction X as the transportation direction.

The liquid discharging head 23 is configured to discharge the liquid onto the medium 3 for recording. The liquid discharging head 23 is mounted on a carriage, which is not illustrated. The carriage is configured to reciprocate along a carriage guiding shaft, which is not illustrated, in the second direction Y as a scanning direction which intersects the first direction X as the transportation direction of the medium 3. A lower surface of the liquid discharging head 23 is a discharging surface from which the ink is discharged. At the discharging surface, a nozzle for discharging the ink is disposed. The liquid discharging head 23 in this embodiment employs a piezoelectric element as a drive element. The piezoelectric element is expanded by applying a voltage for a predetermined duration across electrodes at end portions of the piezoelectric element and changes the shape of the side wall of the ink passage. Expansion or contraction of the piezoelectric element leads to volume contraction of the ink passage, and the ink in the form of ink droplets is discharged in an amount corresponding to the amount of the contraction. The liquid discharging head 23 may not employ the piezoelectric element as the drive element, and may employ any other drive system for discharging the ink.

The medium 3 may be made of paper, vinyl chloride resin, or cloth (a fabric made of cotton, hemp, or silk). The thickness of the above material may be any value. The medium 3 may be a disc such as a CD or a DVD.

The medium supporter 25 is a supporting member disposed to face the discharging surface of the liquid discharging head 23. A support surface of the medium supporter 25 has a part positioned below the liquid discharging head 23, which is used to define a gap between the support surface and the discharging surface of the liquid discharging head 23. At least a part of the medium supporter 25 employs the mesh member 1 in the above-described embodiments of the invention.

In addition to the above-described irradiation portion 33 configured to apply the electromagnetic wave, the heater 27 includes a reflector 34 which is a reflective plate for reflecting the electromagnetic wave that travels downstream, a sensor 35 configured to detect the radiant heat from the heated medium 3 as temperature information, and a controller, which is not illustrated, configured to control the input to the irradiation portion 33 based on the temperature information detected by the sensor 35. The electromagnetic wave incident on the medium 3 includes the electromagnetic wave emitted directly from the irradiation portion 33 and the electromagnetic wave reflected by the reflector 34. The electromagnetic wave includes visible light in addition to infrared rays and ultraviolet rays.

This embodiment employs an infrared ray as an example of an electromagnetic wave, an infrared ray heater as the irradiation portion 33, and an infrared ray detection sensor as a sensor 35.

A heater 27 having the above-described configuration is used as an auxiliary heater, which is not illustrated, in the recording area 37 where the liquid discharging head 23 is disposed. The auxiliary heater performs a preheating process at a temperature of about 50° C. In a main drying area 39 located downstream of the recording area 37, the heater 27, which is illustrated in FIG. 10, is used as a heater for curing the ink at a temperature in a range of about 60° C. to 120° C. to cure and fix the ink. The mesh member 1 is disposed in the main drying area 39 where the heater 27 for curing the ink is disposed.

The transportation unit 29 is configured to transport the medium 3 from a feeding shaft 41 to a take-up shaft 43 through the recording area 37 and the main drying area 39. In this embodiment in FIG. 9, the transportation unit 29 includes a medium transportation passage 31 extending between the feeding shaft 41 and the take-up shaft 43, a feeding roller 47 composed of a pair of nip rollers and positioned upstream of the recording area 37, a discharge roller 49 composed of a pair of nip rollers and positioned downstream of the recording area 37, and a guiding roller 51 positioned at a predetermined position in the medium transportation route 31.

In the liquid discharge apparatus 21 having the above-described configuration of this embodiment, the mesh member 1 allows the medium supporter 25 of the liquid discharging apparatus 21 to have desired high permeability to vapor and high strength enabling the medium supporter 25 to be repeatedly used as the supporting member. In addition, the front corner 5 or another part of the medium 3 is less likely to catch on the second strand 9, which reduces the risk that an area outside the recording surface will be blotted with the ink. Thus, the liquid discharging apparatus 21 has high transportation stability, in which risk that the front corner 5 or another part of the medium 3 will be folded or damaged is reduced.

### OTHER EMBODIMENTS

The mesh member 1, the method of producing the mesh member, and the liquid discharging apparatus 21 according to the aspects of the invention basically have the above described configurations. However, a part of the configuration may be changed or a part of the configuration may be eliminated within a scope of the invention. For example, the material of the mesh member 1 (a material of the strand) is not limited to the stainless steel. The mesh member 1 may be made of any metal material other than the stainless steel, or may include the first strand 7 or the second strand 9 that is made of twisted natural fibers or twisted synthetic fibers. The ranges of the diameters D1, D2 of the first strand 7 and the second strand 9 presented in the first embodiment are applicable only to the mesh member 1 that is made of the stainless steel. The mesh member 1 made of a material other than the stainless steel may have any suitable ranges of the diameters D1, D2 depending on the material.

The combination of the number of strands in the first strands 7 and the number of strands in the second strands 9 presented in the second embodiment is merely one example of the invention. Different combinations that can provide the same operations and advantages as those described above may be employed. In addition, the mesh member 1 may have a complex configuration in which the combination of the diameters of the first strand 7 and the second strand 9, which is described in the first embodiment, and the combination of the numbers of strands in the first strands 7 and in the second strands 9, which is described in the second embodiment, are combined.

The relation of the interval P1 between the adjacent first strands 7 and the interval P2 between the adjacent second strands 9, which is described in the third embodiment, may be applied to the mesh member 1B in the second embodiment or may be applied to the above-described mesh member 1 having the complex configuration in which the configuration of the first embodiment and the configuration of the second embodiment are combined.

The entire disclosure of Japanese Patent Application No. 2014-036970, filed Feb. 27, 2014 is expressly incorporated reference herein.

What is claimed is:

1. A mesh member comprising:
first strands extending in a first direction; and
second strands extending in a second direction intersecting the first direction; wherein
the first strands and the second strands being woven together to cross over and under each other and form a mesh structure, and
the first strands each have a larger cross-sectional area than the second strands at intersections where the first strands and the second strands cross each other.

2. The mesh member according to claim 1, wherein each of the first strands has a larger diameter than each of the second strands.

3. The mesh member according to claim 2, wherein
the mesh member is made of stainless steel,
the diameter of each of the first strands is 300 μm or less, and
the diameter of each of the second strands is 70 μm or more.

4. The mesh member according to claim 2, wherein a ratio of the diameter of each of the first strands to the diameter of each of the second strands is in a range of 2:1 to 4:1.

5. The mesh member according to claim 1, wherein, at the intersections in the mesh structure, the first strands each include a bundle of strands, and the second strands each include one strand or a bundle of strands, the number of strands in the bundle of the second strand being smaller than the number of strands in the bundle of the first strand.

6. The mesh member according to claim 1, wherein the first strands adjacent to each other have a smaller interval therebetween than the second strands adjacent to each other.

7. The mesh member according to claim 1, wherein
the intersections of the mesh member include first intersections where the first strands are positioned over the second strands and second intersections where the second strands are positioned over the first strands,
in the horizontally orientated mesh member, tips of the first strands at the first intersections are positioned higher than tips of the second strands at the second intersection.

8. The mesh member according to claim 7, wherein the mesh member is configured such that a medium having a sheet form and placed on the mesh member is in contact with the tips of the first strands, at the first intersections, where the first strands are positioned over the second strands, and is not in contact with the tips of the second strands at the second intersections, where the second strands are positioned over the first strands.

9. The medium according to claim 1, wherein the mesh member has an opening percentage in a range of 10% to 60%.

10. A method of producing a mesh member comprising:
weaving first strands extending in a first direction and second strands extending in a second direction intersecting the first direction so as to cross over and under each other and form a mesh structure, the first strands each having a larger diameter than the second strands;
tensioning the second strands with a large force during weaving such that the second strands are stretched linearly at the intersections where the first strands and the second strands intersect each other; and
tensioning the first strands with a small force during weaving such that the first strands each form a wavy shape.

11. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 1.

12. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 2.

13. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 3.

14. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 4.

15. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 5.

16. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 6.

17. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 7.

18. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 8.

19. A liquid discharging apparatus comprising:
a liquid discharging head configured to discharge liquid onto a medium;
a medium support configured to support the medium onto which the liquid is discharged;
a heater configured to heat and dry the liquid discharged onto the medium; and
a transportation unit configured to transport the medium in a predetermined direction, wherein
the medium supporter includes at least a part composed of the mesh member according to claim 9.
